(19) United States
(12) Patent Application Publication
(10) Pub. No.: US 2026/0233367 A1
(43) Pub. Date: Aug. 13, 2026

(54) Impact wrench and method for controlling an impact wrench

(71) Applicant: Hilti Aktiengesellschaft, Schaan (LI)

(72) Inventors: Lukas BRAUN, Kriens (CH); Dario BRALLA, Buchs (CH); Matthias HELLER, Jengen (DE)

(21) Appl. No.: 19/164,504

(22) PCT Filed: Mar. 4, 2024
(86) PCT No.: PCT/EP2024/055546

§ 371 Date: Sep. 11, 2025

(30) Foreign Application Priority Data
Mar. 30, 2023 (EP) 23165522.6

(51) Int. Cl. B25B 21/02; B25B 23/147

(52) U.S. Cl. CPC B25B 21/02; B25B 23/1475

(57) ABSTRACT

An impact wrench including a tool fitting, mounted on a drive shaft, for accepting a tool, wherein the drive shaft can be set in a tangentially striking motion via a rotary impact drive that can be driven via a drive, and wherein the rotary impact drive has an anvil associated with the drive shaft, a hammer, and a spring element, which acts on the hammer, wherein the drive is operatively connected to the hammer via a guide slot, and wherein the impact wrench has a control system for controlling the drive on the basis of a measured input value. A state of the spring element is determined as a measured input value and the drive is controlled in accordance with the state of the spring element, thereby enabling particularly comfortable work with the impact wrench. A method for controlling an impact wrench is also provided.

The invention relates to a power tool having a rotary impact drive, in particular to an impact wrench.

### BACKGROUND

To achieve as complete as possible transfer of momentum from the hammer to the anvil and to avoid vibration, the hammer should as far as possible strike the anvil tangentially. However, depending on the situation in which the impact wrench is used by a user, e.g. depending on what tool is accommodated in the tool fitting, the type of workpiece to be worked upon by the tool etc., mishits may occur, in which the hammer does not strike the anvil tangentially, at least not completely.

### SUMMARY OF THE INVENTION

It may strike the anvil axially, that is to say parallel to the drive shaft, for example. In such a case, significant vibration may be generated. Moreover, the power of the impact wrench that is effectively transmitted to the tool fitting may be considerably reduced as a result.

Therefore, to enable the impact wrench to be used in as versatile a way as possible, in particular in different situations of use, it would be desirable if the impact wrench could provide a high power at its tool fitting in as far as possible any situation of use. Vibration during the operation of the impact wrench should be avoided as far as possible.

However, it is not normally possible for the impact wrench to easily detect the specific situation of use, and therefore, for control purposes, the control system cannot rely on input parameters that directly describe the situation of use.

It is an object of the present invention to offer an impact wrench and a method for controlling an impact wrench which allow quick and comfortable, in particular low-vibration, working in different situations of use.

The present invention provides an impact wrench comprising a tool fitting, mounted on a drive shaft, for accepting a tool, in particular a screwing tool, wherein the drive shaft can be set in a tangentially striking motion by means of a rotary impact drive that can be driven via a drive, and wherein the rotary impact drive has an anvil associated with the drive shaft, a hammer, and a spring element, which acts on the hammer, wherein the drive is operatively connected to the hammer via a guide slot, and wherein the impact wrench has a control system for controlling the drive on the basis of a measured input value, wherein the measured input value corresponds to a state of the spring element.

One fundamental consideration here is that comfortable, in particular quick, working is possible if the tool fitting can be driven with a maximum possible torque. For this purpose, all impacts by the hammer on the anvil should take place tangentially. In this case, there is then also no or only slight vibration in the axial direction. For this purpose, it would be possible in theory to repeatedly determine the point of impact of the hammer on the anvil and then to control the drive by means of the control system in accordance with the point of impact. However, direct determination of this point of impact is possible only with a great deal of technical effort. Moreover, by the very nature of the case, continuous control on the basis of the point of impact, which is only ever defined at times of events, in particular at the times at which impacts of the hammer on the anvil actually take place, is not possible.

It is here that the solution proposed here intervenes. This is because it has been recognized that the state of the spring element can be particularly useful as a correlate of the point of impact or at least as a measure for monitoring the impact behavior.

Thus, if the variation in the state of the spring element with respect to time is monitored, local minima and local maxima can each correspond to times at which the hammer reverses its direction of motion. In particular, the local minima can correspond to impacts on the anvil or at least return points of the hammer in the vicinity of the anvil. Local maxima can each correspond to points of reversal of the direction of motion of the hammer in the vicinity of the drive.

The state can also be detected continuously, in particular in contrast to the detection of times for example, e.g. the times at which the hammer strikes the anvil. Thus, by means of the state, it is possible to predict an impact that is about to occur.

The absolute value of the state at its local minimum or its local maximum may be indicative of whether an optimum impact takes place or will take place. The impact behavior can thus be controlled by means of such a prediction of the value at the next local minimum and/or at the next local maximum.

Thus, by analyzing the state of the spring element, in particular by analyzing the variation in its state with respect to time, the control system can control the drive, e.g. increasing or lowering its torque, in such a way that the absolute value of the state at the local minima and/or at the local maxima remains in or is shifted into respectively desired ranges. It can then be expected that at least a large proportion of the impacts of the hammer will strike the anvil in an optimum manner, in particular tangentially, and thus that low losses and disturbances in the form of unwanted vibration will occur.

Since this type of control can be applied largely independently of the respective way in which the impact wrench is used, rapid and comfortable, in particular low-vibration, working in different situations of use is possible with such an impact wrench.

It is conceivable to directly determine the measured input value, that is to say the state. For example, a stress sensor, e.g. a strain gauge or a pressure sensor, can be arranged in and/or on the spring element.

It is also possible to determine the measured input value indirectly. For example, the measured input value can be determined as a relative value between an angular position of the hammer and an angular position of the drive. The angular positions can correspond to rotation angles relative to a zero position and about a longitudinal axis formed by the drive and the drive shaft.

In conjunction with the guide slot, it is possible to obtain from the difference between the two angular positions a measure which correlates with the state of the spring element, e.g. a state of stress of the spring element. Such a difference between the angular positions can also correlate with a position of the hammer, at least over a wide range. In particular, it can correlate with the position of the hammer along the longitudinal axis.

For this purpose, the impact wrench can have a first sensor for detecting the angular position of the hammer. The first sensor can be an optical sensor, for example.

The impact wrench can have a second sensor for detecting the angular position of the drive. The second sensor can be arranged at least partially on the drive.

The second sensor can comprise a magnetic sensor, for example. The magnetic sensor can be a Hall-effect sensor

From the above considerations, it would appear to be advantageous if the control system is designed to control a torque of the drive in accordance with a local minimum value of the state. In particular, the variation in the state with respect to time can be analyzed and times of local minima and/or at least one absolute value of the state at the respective local minimum can be determined. It is thereby possible to control the impact behavior of the hammer relative to the anvil.

Furthermore, unwanted vibration, in this case, for example, due to the impact of the hammer on the drive, can be avoided if the control system is designed to control a torque of the drive in accordance with a maximum value of the state of stress.

In this case, the drive can comprise a brushless motor.

Also included within the scope of the invention is a method for controlling an impact wrench, wherein the impact wrench comprises a tool fitting, mounted on a drive shaft, for accepting a tool, in particular a screwing tool, wherein the drive shaft can be set in a tangentially striking motion by means of a rotary impact drive that can be driven via a drive, and wherein the rotary impact drive has an anvil associated with the drive shaft, a hammer, and a spring element, which acts on the hammer, wherein the drive is operatively connected to the hammer via a guide slot, and wherein the impact wrench has a control system for controlling the drive on the basis of a measured input value, wherein a state of the spring element is determined as a measured input value and a rotation frequency of the drive is controlled in accordance with the detected state.

By means of the method, it is possible to avoid mishits by the hammer. Axial vibration can be reduced. The torque transmitted to the tool fitting can be maximized. Thus, particularly quick and therefore comfortable work with an impact wrench that implements the method is achieved. By means of the method, it is also possible to avoid unwanted vibration. Work with such an impact wrench can thus take place in a way that is particularly comfortable and healthy.

The method can provide for a local minimum of the measured input value to be determined, and for the drive to be controlled in accordance with this minimum. In particular, a variation in the measured input value with respect to time can be monitored. From the variation with respect to time it is possible to determine one or more local minima of the measured input value. Depending on the type of drive, it is conceivable to control a torque and/or a rotation frequency of the drive.

Alternatively or in addition, it is conceivable for a local maximum of the measured input value to be determined, and for the drive to be controlled in accordance with this local maximum.

The local minima and the local maxima can be correlates of different situations. For example, the local minima can correspond to times at which the hammer is at least in the vicinity of the anvil. The local maxima can correspond to times at which the hammer is remote from the anvil, e.g. in the vicinity of the drive.

It is also conceivable to determine and/or predict a trajectory of the measured input value. Thus, continuous, predictive control can be performed.

In particular it is conceivable for this purpose for the measured input value to be evaluated while the hammer is approaching the anvil and/or moving away from the latter. In particular, the measured input value can be evaluated at times during which the hammer is not in contact with the anvil and/or the drive shaft.

It is conceivable for the measured input value to be determined directly and/or indirectly. Indirect determination can be carried out by measuring one or more measured values by means of sensors, said measured values relating in particular to the rotary impact drive. From the measured values it is then possible to infer the state. For example, an angular position of the hammer can be measured. It is also possible to measure an angular position of the drive. From the difference between the two angular positions, it is then possible to infer the state of the spring element.

The control system can implement closed-loop control. The closed-loop control can comprise linear and/or non-linear closed-loop control. It can be based on a network capable of machine training, for example. In particular, the control system can perform control in the manner of a closed-loop model-predictive control system.

The control system can comprise and/or form one or more controllers.

A controller can control the drive in accordance with the local minima. This controller can preferably be activated in a standard way in order to ensure stable impact behavior during normal operation.

A controller can control the drive in accordance with the local maxima. This controller can be activated, for example, when a limit value is exceeded.

A controller which controls the drive both in accordance with the local minima and with the local maxima is also conceivable.

The controller or controllers can be activated and/or deactivated in accordance with the measured input value, i.e. the state, and/or one of the angular positions. By selective activation or deactivation of controllers, the computing power requirement and/or the energy requirement of the control system can be reduced.

Further features and advantages of the invention will be apparent from the detailed description of exemplary embodiments of the invention that follows, with reference to the figures of the drawing, which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

### BRIEF DESCRIPTION OF THE DRAWIGNS

Exemplary embodiments of the invention are illustrated in the schematic drawing and elucidated in detail in the description that follows.

In the figures:

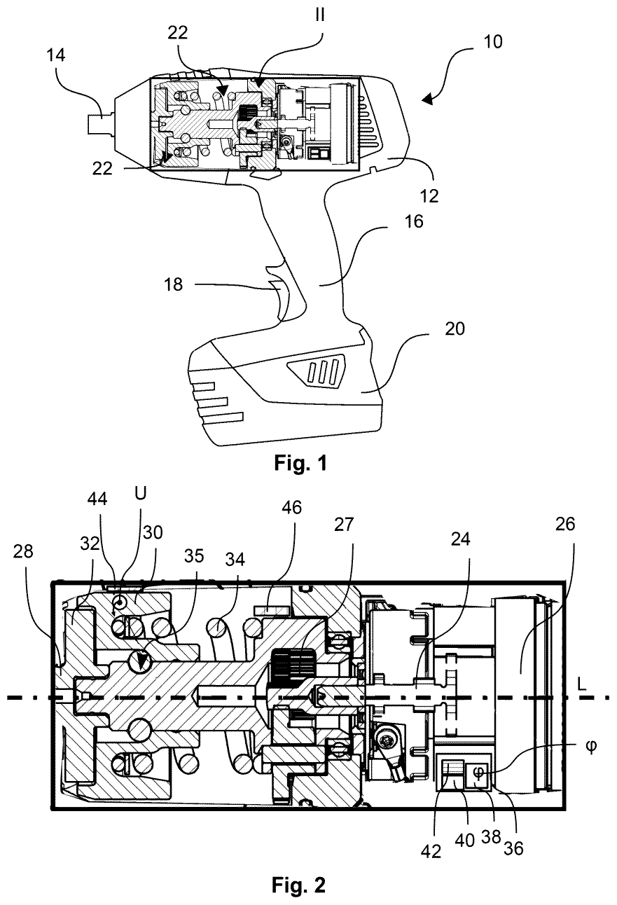

FIG. 1 shows a partially cut-away view of an impact wrench;

FIG. 2 shows a sectional view of a rotary impact drive of the impact wrench from FIG. 1;

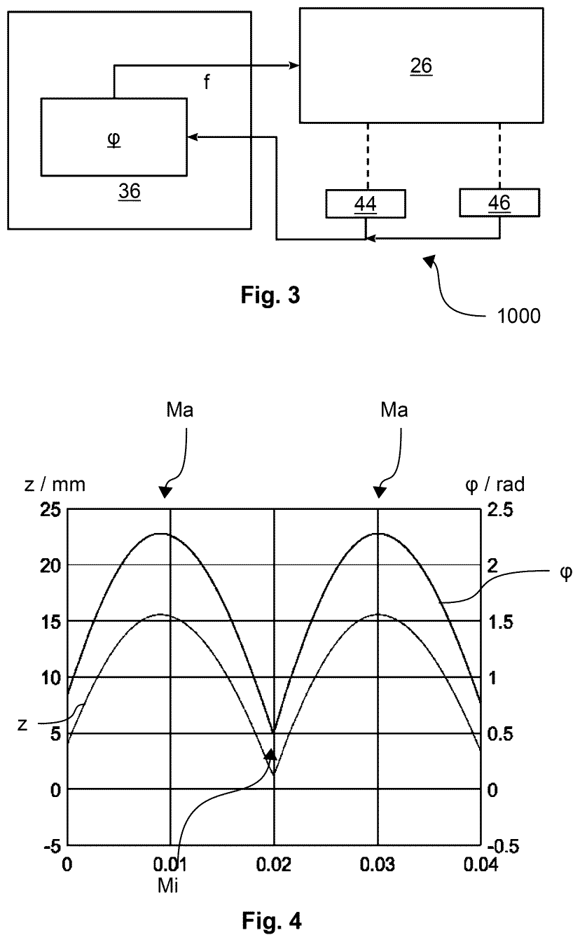

FIG. 3 shows a method for controlling the impact wrench; and

FIGS. 4, 5 and 6 show diagrams illustrating the relationship with respect to time between a measured input value and a position of a hammer.

### DETAILED DESCRIPTION

In the description of the figures that follows, comprehension of the invention is facilitated by use of the same reference signs in each case for identical or functionally corresponding elements.

FIG. 1 shows a partially cut-away side view of a handheld power tool, in particular an impact wrench 10. It shows a housing 12, from which a tool fitting 14 for accepting a tool, e.g. a screw bit or a socket, projects.

A handle region 16 with an operating element 18 is formed on the housing 12. The operating element 18 is designed for switching on and/or off.

A rechargeable battery pack 20 serves to supply energy to the impact wrench 10. The rechargeable battery pack 20 has lithium-based and/or sodium-based rechargeable batteries, for example. The impact wrench 10 can thus be operated cordlessly. The rechargeable battery pack 20 may have a capacity of at least 20 Wh. The rechargeable battery pack 20 may be configured to provide an electrical power of at least 400 W, in particular as peak power, for example for up to 60 seconds, in particular 10 seconds.

The impact wrench 10 furthermore has a rotary impact drive 22. The rotary impact drive 22 is arranged inside the housing 12. It is illustrated in a partially cut-away view in region II.

FIG. 2 shows details of the rotary impact drive 22 in an enlarged illustration of region II from FIG. 1.

The rotary impact drive 22 is driven by a drive 24. The drive 24 comprises, inter alia, a motor 26 and a transmission 27, e.g. a planetary transmission. The motor 26 may be a brushless motor.

The tool fitting 14 (see FIG. 1) is mounted on a drive shaft 28 and can thus be driven by the latter in rotation, in particular with a tangential striking action.

The drive 24 and the drive shaft 28 define a longitudinal axis L of the impact wrench 10 (see FIG. 1).

The drive 24 drives a hammer 30 which in turn periodically strikes an anvil 32. The anvil 32 in turn merges into the drive shaft 28, with the result that ultimately tangential impacts by the hammer 30 drive the tool fitting 14.

In particular, the hammer 30 can strike the anvil 32 with an optimum impact along a circumferential direction U around the longitudinal axis L and thereby drive the tool fitting 14.

In FIG. 2, the circumferential direction U corresponds to a direction perpendicular to the image plane of FIG. 2 and is therefore depicted merely symbolically in FIG. 2. It thus runs radially around the longitudinal axis L.

The hammer 30 is arranged in such a way that it can be moved parallel to the longitudinal axis L. It is seated on a free end of a spring element 34. The spring element 34 is designed as a helical spring. The opposite, free end of the spring element 34 is seated in the region of the drive 24.

The hammer 30 is guided under constraint along a guide slot 35 and is operatively connected via the latter to the drive 24. The guide slot 35 is approximately V-shaped. Thus, if the drive 24 is put into operation, the hammer 30 is moved periodically backward and forward axially while simultaneously rotating about the longitudinal axis L, with the result that ultimately it strikes periodically against the anvil 32.

To control the striking movements, the impact wrench 10 has a control system 36. The control system 36 comprises a microcontroller 38, on which program code 42 stored in a memory 40 can be executed.

When executed on the microcontroller 38, the program code 42 and thus the control system 36 are designed to use measured values from a first sensor 44 and a second sensor 46 to determine a measured input value φ as a relative value of the measured values from the first sensor 44 and the measured value from the second sensor 46. The control system 36 controls the rotation frequency of the drive 24 according to the measured input value, that is to say, in particular, the relative value determined. Here, the rotation frequency is controlled in accordance with a method that is explained in greater detail in conjunction with FIGS. 3 to 5.

In this case, the first sensor 44 is designed to detect an angular position of the hammer 30. The second sensor 46 is designed to detect an angular position of the drive. As described above, the measured input value φ can thus correspond to the extent to which the spring element 34 is extended or shortened and thereby subjected to a corresponding stress. Over a wide range, the measured input value φ also correlates linearly with the position of the hammer 30 along the longitudinal axis L. Here, the angular positions of the hammer 30 and of the drive are standardized in such a way that a measured input value φ of 0 radians corresponds to the most relaxed state of the spring element 34 and thus also to its greatest length.

The two sensors 44, 46, in particular the second sensor 46, can comprise magnetic sensors, e.g. Hall-effect sensors.

FIG. 3 illustrates a method 1000 in which the control system 36 controls the motor 26, in particular, by controlling a torque of the motor 26 with a rotation frequency f. The method 1000 is implemented by corresponding configuration of the program code 42 (see FIG. 2) and subsequent execution of the program code 42 on the control system 36.

In a variant of the method 1000, it is envisaged that the measured input value φ, that is to say therefore a measure of a state, in particular a state of stress, of the spring element 34 (see FIG. 2), is determined from the measured values of the first sensor 44 and the second sensor 46 by the control system 36.

The control system 36 can then set a torque and thus the rotation frequency f of the motor 26 in accordance with the measured input value φ. By virtue of the set torque or rotation frequency f, the movement of the hammer 30 and of the spring element 34 clamped between the hammer 30 and the drive 24 can be controlled by the control system 36 in the manner of a closed control loop by continuous measurement of the measured values of the sensors 44, 46 and subsequent processing of these measured values.

In particular, the control system 36 can be designed to determine the times and absolute values of local minima and/or local maxima of the measured input value φ in order to control the motor 26.

FIG. 4 to FIG. 6 show diagrams of variations in the measured input value φ, measured in radians, and in a position z, measured in millimeters, of the hammer 30 with respect to time. The position z describes the position of the hammer 30 along the longitudinal axis L. Here, a position z=0 mm corresponds to a position of the hammer 30 in which the hammer 30 can carry out an optimum impact against the anvil 32. The more positive the value of the position z, the closer is the hammer 30 to the free end of the spring element 34, the end facing the drive 24, and thus the further it is from the anvil 32.

In FIG. 4 to FIG. 6, local maxima Ma and local minima Mi of the measured input value φ are also indicated.

FIG. 4 illustrates a situation in which the measured input value φ has a positive absolute value, in this case about 0.5 rad, at the minimum Mi. Thus, at the minimum Mi, the spring element 34 does not reach its most relaxed state. Impacts of the hammer 30 on the anvil 32 take place too early, that is to say before the actually optimum times. In such a situation, the control system 36 can reduce the rotation frequency f by adjusting the torque.

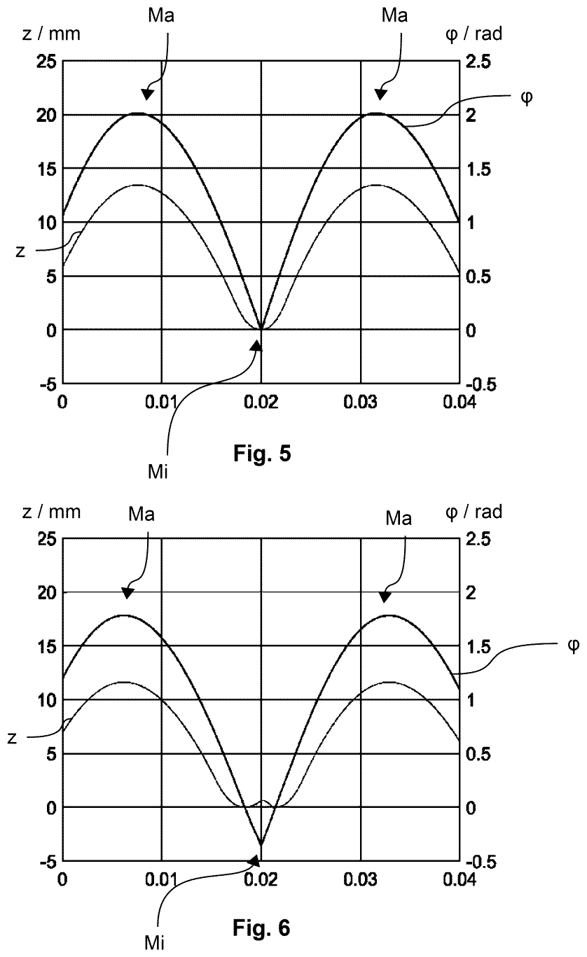

FIG. 5 illustrates a situation in which the measured input value φ has an absolute value of about 0 rad at the minimum Mi. Thus, at the minimum Mi, the spring element 34 is in its most relaxed state. Impacts of the hammer 30 on the anvil 32 thus take place at the optimum time; the control system 36 can maintain the current rotation frequency f. In this case, the spring element 34 can be prestressed, thus ensuring that it has a certain prestress even in this most relaxed state.

FIG. 6 illustrates a situation in which the measured input value φ is negative at the local minimum Mi and reaches approximately −0.3 rad, for example. At the local minimum Mi, the spring element 34 is beyond its envisaged rest position. Impacts of the hammer 30 on the anvil 32 thus take place too late; for correction, the control system 36 can increase the current rotation frequency f by adjusting the torque.

In all three situations shown in FIGS. 4 to 6, it can be seen that the variations in the measured input value φ with respect to time are without sharp bends, i.e. are continuously differentiable, in ranges around the local maxima Ma.

However, it is also conceivable that the measured input value φ will exceed a defined threshold value, in particular a limitation of the measured input value φ may occur. The variation in the measured input value φ with respect to time in the region of the local maxima may have a sharp bend. Such situations may indicate that the hammer 30 is overshooting when sliding back in the direction of the drive 24 or is even striking a stop at the drive 24.

In such a case, the control system 36 can lower the rotation frequency f or briefly deactivate the drive 24, for example, in order to feed less power into the rotary impact drive 22 and thereby reduce or even avoid further unwanted vibration.

### LIST OF REFERENCE SIGNS

10 Impact wrench
12 Housing
14 Tool fitting
16 Handle region
18 Operating element
20 Rechargeable battery pack
22 Rotary impact drive
24 Drive
26 Motor
27 Transmission
28 Drive shaft
30 Hammer
32 Anvil
34 Spring element
35 Guide slot
36 Control system
38 Microcontroller
40 Memory
42 Program code
44 First sensor
46 Second sensor
1000 Method
φ Measured input value
II Region
L Longitudinal axis
Ma Maxima
Mi Minima
U Circumferential direction
f Rotation frequency
z Position

What is claimed is:

1-11. (canceled)

12. An impact wrench comprising:
a tool fitting mounted on a drive shaft and for accepting a tool, the drive shaft settable in a tangentially striking motion via a rotary impact drive drivable via a drive, the rotary impact drive having an anvil associated with the drive shaft, a hammer, and a spring acting on the hammer, the drive being operatively connected to the hammer via a guide slot, and
a controller for controlling the drive on the basis of a measured input value, the measured input value corresponding to a state of the spring.

13. The impact wrench as recited in claim 12 wherein the measured input value is determined as a relative value between an angular position of the hammer and an angular position of the drive.

14. The impact wrench as recited in claim 13 further comprising a first sensor for detecting the angular position of the hammer.

15. The impact wrench as recited in claim 12 further comprising a first sensor for detecting an angular position of the hammer.

16. The impact wrench as recited in claim 14 further comprising a second sensor for detecting the angular position of the drive.

17. The impact wrench as recited in claim 12 further comprising a second sensor for detecting anangular position of the drive.

18. The impact wrench as recited in claim 17 wherein the second sensor includes a magnetic sensor.

19. The impact wrench as recited in claim 16 wherein the second sensor includes a magnetic sensor.

20. The impact wrench as recited in claim 12 wherein the controller is designed to control the drive in accordance with a local minimum of the measured input value.

21. The impact wrench as recited in claim 12 wherein the controller is designed to control the drive in accordance with a local maximum of the measured input value.

22. The impact wrench as recited in claim 12 wherein the tool is a screwing tool.

23. A method for controlling an impact wrench, wherein the impact wrench includes a tool fitting mounted on a drive shaft and for accepting a tool, the drive shaft settable in a tangentially striking motion via a rotary impact drive drivable via a drive, the rotary impact drive having an anvil associated with the drive shaft, a hammer, and a spring acting on the hammer, the drive being operatively connected to the hammer via a guide slot, and a controller for controlling the drive on the basis of a measured input value, the method comprising:
determining a state of the spring as the measured input value; and
controlling the drive in accordance with the state of the spring element.

24. The method as recited in claim 23 wherein a local minimum of the measured input value is determined, and the drive is controlled in accordance with the local minimum.

25. The method as recited in claim 23 wherein a local maximum of the measured input value is determined, and the drive is controlled in accordance with the maximum.

26. The method as recited in claim 23 wherein the measured input value is evaluated while the hammer is moving toward the anvil.

27. The method as recited in claim 23 wherein the measured input value is evaluated while the hammer is moving away from the latter.
